(19) United States
(12) Patent Application Publication
(10) Pub. No.: US 2022/0020529 A1
(43) Pub. Date: Jan. 20, 2022

(54) Inductive device having electromagnetic radiation shielding mechanism and manufacturing method of the same

(71) Applicant: REALTEK SEMICONDUCTOR CORPORATION, HSINCHU (TW)

(72) Inventors: HSIAO-TSUNG YEN, Hsinchu (TW); KA-UN CHAN, Hsinchu (TW)

(21) Appl. No.: 17/199,653

(22) Filed: Mar. 12, 2021

(30) Foreign Application Priority Data
Jul. 20, 2020 (TW) 109124452

(51) Int. Cl. H01F 27/36; H01F 41/02

(52) U.S. Cl. CPC H01F 27/363; H01F 41/02

(57) ABSTRACT

The present invention discloses an inductive device having electromagnetic radiation shielding mechanism used to establish electromagnetic radiation shielding mechanism against an electronic device that includes an inductive unit and a first shielding structure. The first shielding structure forms a closed shape and is disposed next to a side of the inductive unit, wherein the first shielding structure is located between the inductive unit and the electronic device.

### BACKGROUND OF THE INVENTION

### 1. Field of the Invention

The present invention relates to an inductive device having electromagnetic radiation shielding mechanism and a manufacturing method of the same.

### 2. Description of Related Art

Inductive units, e.g. inductors and transformers, are crucial in RF integrated circuits and are used to perform signal conversion, coupling and impedance matching. Since system-on-a-chip becomes a major trend in integrated circuit design, integrated inductors and transformers in the integrated circuits gradually replace conventional independent units and are widely used in RF integrated circuits. However, the integrated inductors and transformers in the integrated circuits are often suffered from external electromagnetic radiation. Also, the integrated inductors and transformers in the integrated circuits may deliver electromagnetic radiation to affect other components in the integrated circuits.

As a result, how to equip the inductors and the transformers in the integrated circuits with electromagnetic radiation shielding mechanism to avoid electromagnetic radiation interference becomes an important issue.

### SUMMARY OF THE INVENTION

In consideration of the problem of the prior art, an object of the present invention is to provide an inductive device having electromagnetic radiation shielding mechanism and a manufacturing method of the same.

The present invention discloses an inductive device having electromagnetic radiation shielding mechanism used to establish electromagnetic radiation shielding mechanism against an electronic device that includes an inductive unit and a first shielding structure. The first shielding structure has a closed shape and is disposed at a neighboring side of the inductive unit and between the inductive unit and the electronic device.

The present invention also discloses an inductive device manufacturing method used to manufacture an inductive device having electromagnetic radiation shielding mechanism used to establish electromagnetic radiation shielding mechanism against an electronic device, the inductive device manufacturing method includes the steps outlined below. An inductive unit is formed. An electromagnetic radiation test is performed on the inductive unit. At least a first shielding structure having a closed shape is formed when an electromagnetic radiation amount related to the inductive unit and the electronic device exceeds a radiation threshold, wherein the first shielding structure is disposed at a neighboring side of the inductive unit and between the inductive unit and the electronic device.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a top view of an inductive device having electromagnetic radiation shielding mechanism according to an embodiment of the present invention.

FIG. 2 illustrates a flow chart of a according to an embodiment of the present invention.

FIG. 3 illustrates a side view of the inductive device in FIG. 1 along an A direction according to an embodiment of the present invention.

FIG. 4 illustrates a diagram of coupling amounts of the electromagnetic radiation generated by the electronic device measured at a terminal of the inductive unit of the inductive device under different operation frequencies of the electronic device according to an embodiment of the present invention.

FIG. 5 illustrates a diagram of coupling amounts of the electromagnetic radiation generated by the electronic device measured by the inductive unit with different shielding structures according to an embodiment of the present invention.

FIG. 6 illustrates a flow chart of an inductive device manufacturing method according to an embodiment of the present invention.

### DETAILED DESCRIPTION OF THE PREFERRED EMBODIMENTS

An aspect of the present invention is to provide an inductive device having electromagnetic radiation shielding mechanism and a manufacturing method of the same to dispose a first shielding structure having a closed shape between an inductive unit and an electronic device that affect each other to provide electromagnetic radiation shielding without decreasing the operation efficiency of the inductive unit. A smaller circuit area can also be maintained.

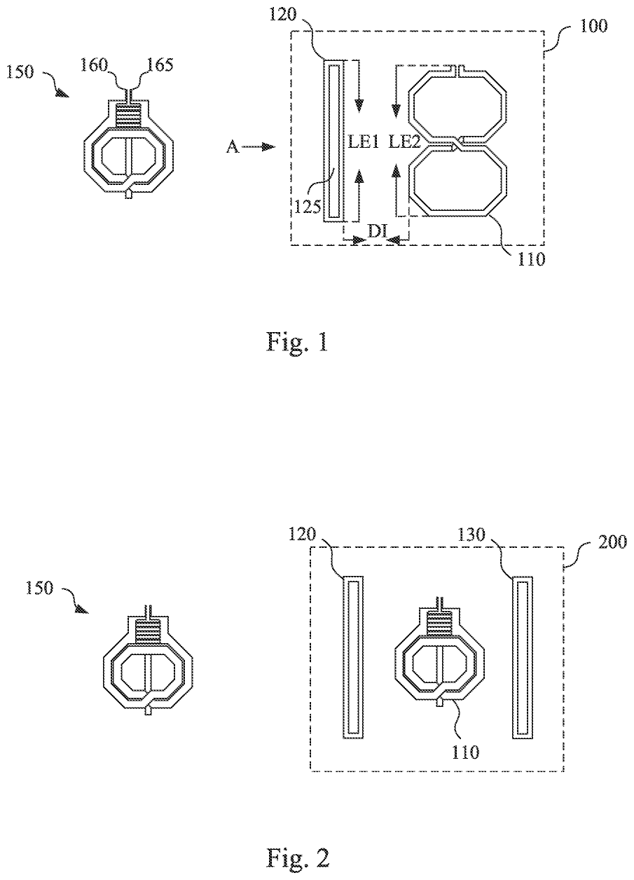

Reference is now made to FIG. 1. FIG. 1 illustrates a top view of an inductive device 100 having electromagnetic radiation shielding mechanism according to an embodiment of the present invention.

The inductive device 100 is able to establish an electromagnetic magnetic shielding against the electronic device 150. The electronic device 150 can be such as, but not limited to an inductor having two terminals 160 and 165. One of the terminals 160 and 165 acts as a signal input terminal while the other one of the terminals 160 and 165 acts as a signal output terminal. The inductive device 100 can establish the electromagnetic magnetic shielding without affecting the operation thereof, e.g. the amount of quality factor, to avoid the interference between the inductive device 100 and the electronic device 150.

The inductive device 100 includes an inductive unit 110 and a first shielding structure 120.

The inductive unit 110 includes a component of such as, but not limited to an integrated circuit inductor or an integrated circuit transformer. In an embodiment, the inductive unit 110 operates as such as, but not limited to a voltage control oscillator (VCO) or a power amplifier. However, the present invention is not limited thereto.

The inductive unit 110 generates internal electromagnetic radiation to affect the external circuit components disposed in the neighboring area, e.g. the electronic device 150. On the contrary, the external circuit components, e.g. the electronic device 150 also generates external electromagnetic radiation to affect the operation of the inductive unit 110.

As illustrated in FIG. 1, the first shielding structure 120 has a closed shape and is disposed at a neighboring side of the inductive unit 110 and between the inductive unit 110 and the electronic device 150. In an embodiment, the material of the first shielding structure 120 is metal. The shape of the first shielding structure 120 can be such as, but not limited to a ring shape, a rectangular shape or other shapes that forms an enclosed area 125. In FIG. 1, the shape of the first shielding structure 120 is exemplarily illustrated as a rectangular shape. However, the present invention is not limited thereto. Furthermore, the first shielding structure 120 is electrically isolated (not electrically coupled to any voltage source or ground terminal) or grounded.

When an electromagnetic radiation is generated nearby the first shielding structure 120, whether from the inductive unit 110 or the electronic device 150, the first shielding structure 120 having the closed shape generates an induced current to further generate a magnetic field against the electromagnetic radiation.

As a result, the first shielding structure 120 can prevent the inductive unit 110 from being affected by the external electromagnetic radiation from the electronic device 150, or prevent the electronic device 150 from being affected by the leaked electromagnetic radiation from the inductive unit 110.

In an embodiment, as illustrated in FIG. 1, the first shielding structure 120 has a stretching length LE1 along a direction and the inductive unit has a side length LE2 corresponding to the direction, wherein the stretching length LE1 is larger than the side length LE2 to accomplish a better shielding effect.

In FIG. 1, one first shielding structure 120 disposed neighboring to the inductive unit 110 is illustrated as an example. In other embodiments, a multiple of first shielding structures 120 can be disposed neighboring to the inductive unit 110. In an embodiment, a multiple of first shielding structures 120 not only provide the electromagnetic radiation shielding mechanism, but also function as redundant metal blocks at the same time.

In FIG. 1, in order to make the figure clear, a distance DI between the first shielding structure 120 and the inductive unit 110 is illustrated to be longer. In practical implementation, under the condition that the first shielding structure 120 and the inductive unit 110 do not contact each other, a better shielding effect can be obtained when the distance DI is shorter without affecting the operation of the inductive unit 110. In an embodiment, the distance DI between the first shielding structure 120 and the inductive unit 110 is 2 micrometers (μm).

In integrated circuits, the inductive units are easily affected by each other due to the coupling effect. When the inductive units include the voltage control oscillator or the power amplifier, the electromagnetic radiation is particularly easy to be generated to affect the operation of other circuits. In some approaches, a shielding structure having a closed shape is formed to surround the whole inductive unit. However, though the electromagnetic radiation shielding mechanism is provided, such a design also affects the quality factor of the inductive unit when the distance between the shielding structure and the inductive unit is too small. The efficiency of the inductive unit thus decreased. However, if the distance is designed to be larger, the circuit area may become too large.

As a result, the inductive device 100 of the present invention provides the electromagnetic radiation shielding mechanism, under the condition that the operation efficiency of the inductive unit 110 is not affected, by using the first shielding structure 120 having the closed shaped disposed between the inductive unit 110 and the electronic device 150 that may affect each other. The quality factor of the inductive unit can thus be maintained. Further, the first shielding structure 120 can be disposed neighboring to the inductive unit 110 with a shorter distance to keep a smaller circuit area.

In an embodiment, the inductive unit 110 is an 8-shaped inductor or an 8-shaped transformer, as illustrated in FIG. 1. Under such a condition, since the 8-shaped inductor includes coils winding in the clockwise direction and in the counter clockwise direction at the same time, the induced currents generated in the first shielding structure 120 cancel out each other. As a result, the inductive device 100 only requires the first shielding structure 120 to be disposed at a side of the inductive unit 110 to provide the electromagnetic radiation shielding mechanism without affecting the quality factor of the inductive unit 110.

Similarly, when the electronic device 150 generates the electromagnetic radiation such that the first shielding structure 120 generates the corresponding induced current, such that the electromagnetic radiation of the induced current couples to the 8-shaped inductor, the 8-shaped inductor is also not affected due to the winding of the coils described above.

In another embodiment, the inductive unit 110 can be other inductive units having a symmetrical structure, such as but not limited to a twins inductor.

Reference is now made to FIG. 2. FIG. 2 illustrates a top view of an inductive device 200 having electromagnetic radiation shielding mechanism according to an embodiment of the present invention. Similar to the inductive device 100 in FIG. 1, the inductive device 200 in FIG. 2 includes the inductive unit 110 and the first shielding structure 120. However, in the present embodiment, the inductive device 200 further includes a second shielding structure 130, in which the second shielding structure 130 also has a closed shaped.

In an embodiment, the inductive unit 110 is a non-8-shaped inductor. Under such a condition, when only the first shielding structure 120 is disposed, the quality factor may drop 0-20% according to different structures of the inductive unit 110. As a result, besides the first shielding structure 120, the second shielding structure 130 is preferably disposed at another neighboring side of the inductive unit 110 opposite to the first shielding structure 120 to maintain the symmetrical electromagnetic environment of the inductive unit 110. Preferably, the distance between the second shielding structure 130 and the inductive unit 110 is the same as the distance between the first shielding structure 120 and the inductive unit 110 to maintain the electromagnetic environment of the inductive unit 110.

In an embodiment, the inductive unit 110 can be also a metal wire. When the metal wire is also inductive when a signal is transmitted therethrough to generate a magnetic field. By disposing the first shielding structure 120, the electromagnetic radiation shielding can also be performed on the inductive unit 110 implemented by the metal wire.

In different embodiments, the first shielding structure 120 can be disposed at different positions relative to the inductive unit 110.

For example, in an embodiment, the inductive unit 110 is disposed in a circuit layer. The first shielding structure 120 and the inductive unit 110 are selectively formed at either a same plane or difference planes of the same circuit layer. In another embodiment, the first shielding structure 120 and the inductive unit 110 are formed at different circuit layers. In yet another embodiment, the first shielding structure 120 may include different components formed in different circuit layers.

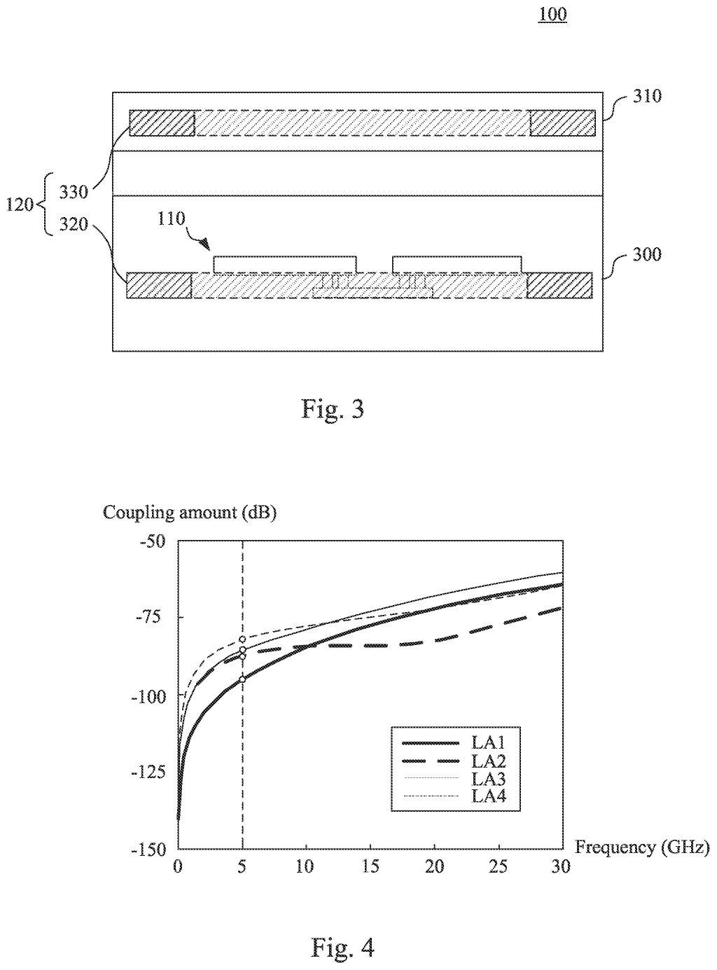

Reference is now made to FIG. 3. FIG. 3 illustrates a side view of the inductive device 100 in FIG. 1 along an A direction according to an embodiment of the present invention.

In an embodiment, the inductive device 100 is disposed in a circuit layer 300, in which another circuit layer 310 is adjacent and above the circuit layer 300. In an embodiment, the circuit layer 300 and the circuit layer 310 are a redistribution layer (RDL) and an ultra thick metal layer (UTM) respectively.

In an embodiment, the first shielding structure 120 actually includes a first shielding unit 320 and a second shielding unit 330 respectively having a closed shape. The first shielding unit 320 and the inductive unit 110 are formed in the same circuit layer, and the second shielding unit 330 and the inductive unit 110 are formed in different circuit layers. More specifically, the first shielding unit 320 is disposed in the circuit layer 300 and the second shielding unit 330 is disposed in the circuit layer 310.

As a result, the inductive device can be disposed in different positions depending on practical requirements, to accomplish the best electromagnetic radiation shielding effect.

Reference is now made to FIG. 4. FIG. 4 illustrates a diagram of coupling amounts of the electromagnetic radiation generated by the electronic device 150 measured at a terminal of the inductive unit 110 of the inductive device 100 under different operation frequencies of the electronic device 150 according to an embodiment of the present invention. In FIG. 4, the X-axis corresponds to the frequency having the unit of GHz, and the Y-axis corresponds to the coupling amount having the unit of dB.

Four different line sections LA1˜LA4 are illustrated in FIG. 4. The line section LA1 illustrated by using a thick solid line represents the coupling amount of the electromagnetic radiation generated by the electronic device 150 under the condition that the terminals 160 and 165 are operated as a signal input terminal and a signal output terminal respectively, and measured by the inductive unit 110 when the first shielding structure 120 is disposed at a side of the inductive unit 110.

The line section LA2 illustrated by using a thick dashed line represents the coupling amount of the electromagnetic radiation generated by the electronic device 150 under the condition that the terminals 160 and 165 are operated as a signal input terminal and a signal output terminal respectively, and measured by the inductive unit 110 when the first shielding structure 120 is absent at the side of the inductive unit 110.

In comparison with the two previously mentioned conditions, the coupling amount of the electromagnetic radiation under 5 GHz when the first shielding structure 120 is presented is lower than the coupling amount of the electromagnetic radiation under 5 GHz when the first shielding structure 120 is absent by 7 dB.

Further, the line section LA3 illustrated by using a thin solid line represents the coupling amount of the electromagnetic radiation generated by the electronic device 150 under the condition that the terminals 165 and 160 are operated as a signal input terminal and a signal output terminal respectively, and measured by the inductive unit 110 when the first shielding structure 120 is disposed at the side of the inductive unit 110.

The line section LA4 illustrated by using a thin dashed line represents the coupling amount of the electromagnetic radiation generated by the electronic device 150 under the condition that the terminals 165 and 160 are operated as a signal input terminal and a signal output terminal respectively, and measured by the inductive unit 110 when the first shielding structure 120 is absent at the side of the inductive unit 110.

In comparison with the two previously mentioned conditions, the coupling amount of the electromagnetic radiation under 5 GHz when the first shielding structure 120 is presented is lower than the coupling amount of the electromagnetic radiation under 5 GHz when the first shielding structure 120 is absent by 3 dB.

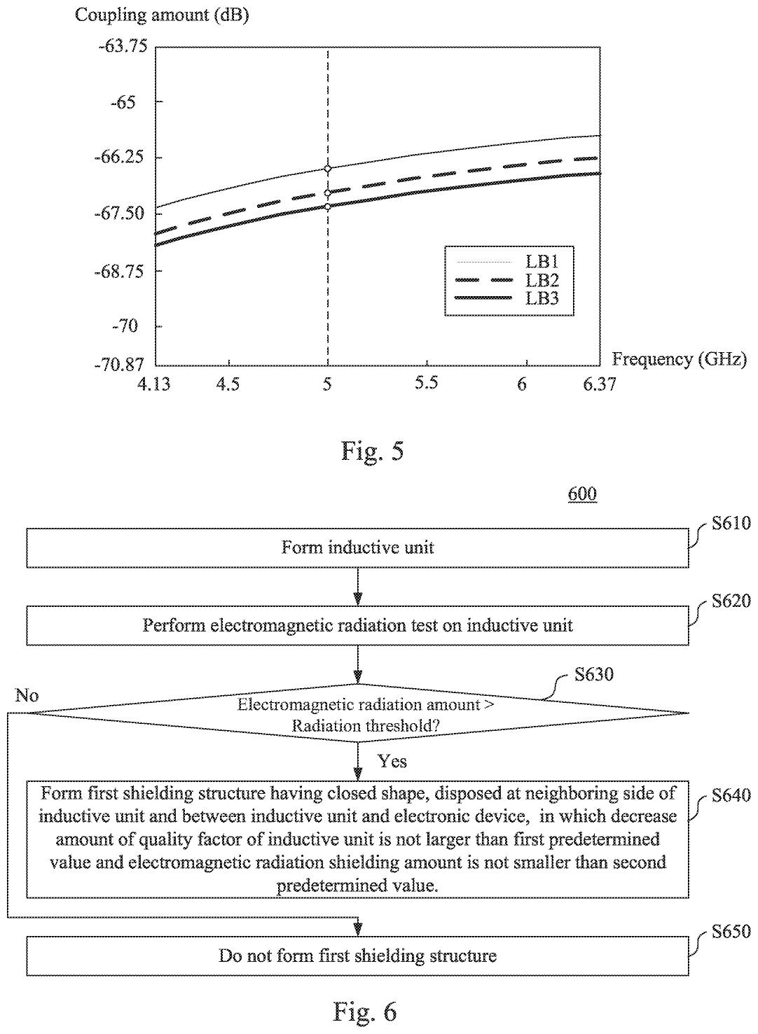

Reference is now made to FIG. 5. FIG. 5 illustrates a diagram of coupling amounts of the electromagnetic radiation generated by the electronic device 150 measured by the inductive unit 110 with different shielding structures according to an embodiment of the present invention. In FIG. 5, the X-axis corresponds to the frequency having the unit of GHz, and the Y-axis corresponds to the coupling amount having the unit of dB.

Three different line sections LB1˜LB3 are illustrated in FIG. 5. The line section LB1 illustrated by using a thin solid line represents the condition that no shielding structure is formed nearby the inductive unit 110. The line section LB2 illustrated by using a thick dashed line represents the condition that the first shielding structure 120 disposed in only one circuit layer is presented neighboring to the inductive unit 110. The line section LB3 illustrated by using a thick solid line represents the condition that the shielding units (e.g. the first shielding unit 320 and the second shielding unit 330 in FIG. 3) disposed in different circuit layers (e.g. the circuit layers 300 and 310 in FIG. 3) are presented neighboring to the inductive unit 110.

As illustrated in FIG. 5, when more shielding units are disposed, the coupling amount of the electromagnetic radiation generated by the electronic device 150 measured by the inductive unit 110 is less.

Based on the above description, the first shielding structure 120 may contribute a shielding amount of 2 dB to 7 dB of the electromagnetic radiation generated by the electronic device 150.

Reference is now made to FIG. 6. FIG. 6 illustrates a flow chart of an inductive device manufacturing method 600 according to an embodiment of the present invention.

Besides the apparatus described above, the present invention further discloses the inductive device manufacturing method 600 that can be used to manufacture such as, but not limited to the inductive device 100 illustrated in FIG. 1. An embodiment of the inductive device manufacturing method 600 is illustrated in FIG. 6 and includes the steps outlined below.

In step S610, the inductive unit 110 is formed.

In step S620, an electromagnetic radiation test is performed on the inductive unit 110.

In step S630, whether the electromagnetic radiation amount related to the inductive unit 110 and the electronic device 150 exceeds a radiation threshold is determined.

In step S640, when the electromagnetic radiation amount related to the inductive unit 110 and the electronic device 150 exceeds the radiation threshold, the first shielding structure 120 having the closed shape is formed, wherein the first shielding structure 120 is disposed at a neighboring side of the inductive unit and between the inductive unit and the electronic device. In an embodiment, the decrease amount of the quality factor of the inductive unit 110 is not larger than a first predetermined value and an electromagnetic radiation shielding amount is not smaller than a second predetermined value.

In step S650, when the electromagnetic radiation amount related to the inductive unit 110 and the electronic device 150 does not exceed the radiation threshold, the first shielding structure 120 is not formed.

It is appreciated that the embodiments described above are merely an example. In other embodiments, it should be appreciated that many modifications and changes may be made by those of ordinary skill in the art without departing, from the spirit of the invention.

In summary, the inductive device having electromagnetic radiation shielding mechanism and the manufacturing method of the same of the present invention disposes a first shielding structure having a closed shape between an inductive unit and an electronic device that affect each other to provide electromagnetic radiation shielding without decreasing the operation efficiency of the inductive unit. A smaller circuit area can also be maintained.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. An inductive device having electromagnetic radiation shielding mechanism used to establish electromagnetic radiation shielding mechanism against an electronic device, comprising:
an inductive unit; and
a first shielding structure having a closed shape and disposed at a neighboring side of the inductive unit and between the inductive unit and the electronic device.

2. The inductive device of claim 1, wherein the inductive unit is an 8-shaped inductor, a non-8-shaped inductor or a metal wire.

3. The inductive device of claim 1, wherein the inductive device further includes at least a second shielding structure having the closed shape and disposed at another neighboring side of the inductive unit opposite to the first shielding structure.

4. The inductive device of claim 1, wherein a distance between the first shielding structure and the inductive unit is 2 micrometers.

5. The inductive device of claim 1, wherein the first shielding structure has a stretching length along a direction and the inductive unit has a side length corresponding to the direction, wherein the stretching length is larger than the side length.

6. The inductive device of claim 1, wherein the first shielding structure and the inductive unit are formed at either a same plane or difference planes of a same circuit layer or are formed at different circuit layers.

7. The inductive device of claim 1, wherein the first shielding structure functions as a redundant metal block at the same time.

8. The inductive device of claim 1, wherein the first shielding structure comprises a first shielding unit and a second shielding unit respectively having the closed shape, the first shielding unit is formed at the same circuit layer that the inductive unit is formed and the second shielding unit is formed at a different circuit layer from the circuit layer that the inductive unit is formed.

9. The inductive device of claim 1, wherein the first shielding structure is electrically isolated or grounded.

10. An inductive device manufacturing method used to manufacture an inductive device having electromagnetic radiation shielding mechanism used to establish electromagnetic radiation shielding mechanism against an electronic device, the inductive device manufacturing method comprising:
forming an inductive unit;
performing an electromagnetic radiation test on the inductive unit; and
forming at least a first shielding structure having a closed shape when an electromagnetic radiation amount related to the inductive unit and the electronic device exceeds a radiation threshold, wherein the first shielding structure is disposed at a neighboring side of the inductive unit and between the inductive unit and the electronic device.

11. The inductive device manufacturing method of claim 10, wherein the inductive unit is an 8-shaped inductor, a non-8-shaped inductor or a metal wire.

12. The inductive device manufacturing method of claim 10, further comprising:
forming at least a second shielding structure having the closed shape and disposed at another neighboring side of the inductive unit opposite to the first shielding structure.

13. The inductive device manufacturing method of claim 10, wherein a distance between the first shielding structure and the inductive unit is 2 micrometers.

14. The inductive device manufacturing method of claim 10, wherein the first shielding structure has a stretching length along a direction and the inductive unit has a side length corresponding to the direction, wherein the stretching length is larger than the side length.

15. The inductive device manufacturing method of claim 10, wherein the first shielding structure and the inductive unit are formed at either a same plane or difference planes of a same circuit layer or are formed at different circuit layers.

16. The inductive device manufacturing method of claim 10, wherein the first shielding structure functions as a redundant metal block at the same time.

17. The inductive device manufacturing method of claim 10, wherein the first shielding structure comprises a first shielding unit and a second shielding unit respectively having the closed shape, the first shielding unit is formed at the same circuit layer that the inductive unit is formed and the second shielding unit is formed at a different circuit layer from the circuit layer that the inductive unit is formed.

18. The inductive device manufacturing method of claim 10, wherein the first shielding structure is electrically isolated or grounded.
